(19) United States
(12) Patent Application Publication
(10) Pub. No.: US 2026/0035221 A1
(43) Pub. Date: Feb. 5, 2026

(54) OPERATING VEHICLE WITH VERTICALLY MOVABLE SAFETY SENSOR

(71) Applicant: SYSTEM CERAMICS S.P.A., FIORANO MODENESE (MODENA) (IT)

(72) Inventors: MARCELLO BORGHI, FIORANO MODENESE (MODENA) (IT); ENRICO MERIGHI, FIORANO MODENESE (MODENA) (IT)

(21) Appl. No.: 18/996,403

(22) PCT Filed: Jul. 20, 2023
(86) PCT No.: PCT/IB2023/057396

§ 371 Date: Jan. 17, 2025

(30) Foreign Application Priority Data
Jul. 27, 2022 (IT) 102022000015888

(51) Int. Cl. B66F 9/06; B66F 9/075; B66F 9/18; G01S 17/04

(52) U.S. Cl. CPC B66F 9/063; B66F 9/0755; B66F 9/18; G01S 17/04

(57) ABSTRACT

Operating vehicle that includes a self-propelled unit, structured to move on a movement surface along a given path advancing along a main direction; a fork, associated with an operating part of the self-propelled unit and movable vertically between a lower position and an upper position; a detection sensor, provided with a detecting field and arranged to emit a signal if an object is inside the detecting field, the detecting field facing the space occupied by the fork; a control module, connected to the self-propelled unit and to the detection sensor, which is set up to control a safety manoeuvre of the self-propelled unit in the presence of a detecting signal of the detection sensor. The detection sensor is vertically movable between a lower position and an upper position. The upper position is placed at a higher level than the lower position.

The present invention relates to a loading vehicle provided with lifting forks. In particular, the invention relates to a loading vehicle provided with lifting forks, arranged to be inserted below an object to be transported, and to lift and lower the object as a function of the loading/unloading and transport operations to be carried out.

The invention finds particularly advantageous use in self-driving loading vehicles, for example AGV or LGV.

In general, self-driving loading vehicles are provided with numerous safety sensors, designed to detect the presence of obstacles along the path followed under the control of the self-driving system.

The safety sensors are connected to a vehicle control module which, in the presence of an obstacle, stops the vehicle or temporarily diverts the trajectory thereof. Obviously, the main purpose and function of the safety sensors is to prevent the vehicle from accidentally hitting an obstacle or an operator.

In loading vehicles provided with lifting forks, a safety sensor is provided positioned in an area of the vehicle close to the fork, so that the sensor faces the area of action of the fork itself. Typically, the safety sensor is positioned substantially intermediate the forks and in a lower area of the vehicle. The purpose of the safety sensor is to detect the presence of persons or objects positioned in the operating area of the forks, in particular in the steps in which the vehicle approaches an object to be loaded.

In the current vehicles, the safety sensor is located in a fixed position which, as mentioned, is close to the ground. In cases where the object supported by the fork is to be placed in a raised position, for example on a raised shelf or on a stack of other objects, or is to be picked up from a raised position, the safety sensor is not able to detect obstacles in the area of action of the fork. This limit entails considerable safety risks, as an unexpected impact against an object located at a relatively high level with respect to the ground can cause a dangerous fall.

The object of the present invention is to solve the considerable safety defect of the current vehicles.

The main advantage of the vehicle according to the present invention is to enable the effective detection of obstacles in all steps and driving positions of the fork.

Additional features and advantages of the present invention will become more apparent from the following detailed description of an embodiment of the invention in question, illustrated by way of non-limiting example in the appended figures, in which:

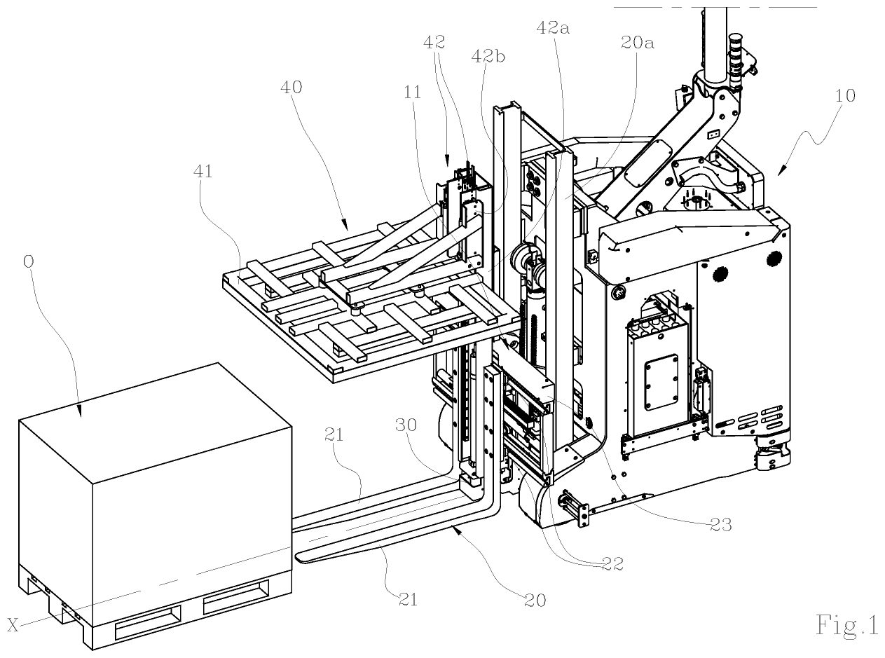

FIG. 1 shows an isometric view of an operating vehicle according to the present invention;

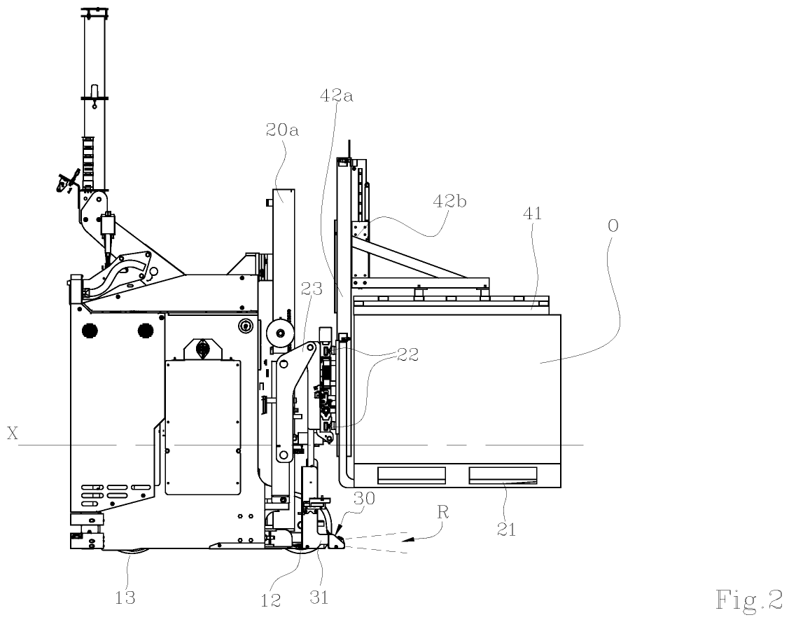

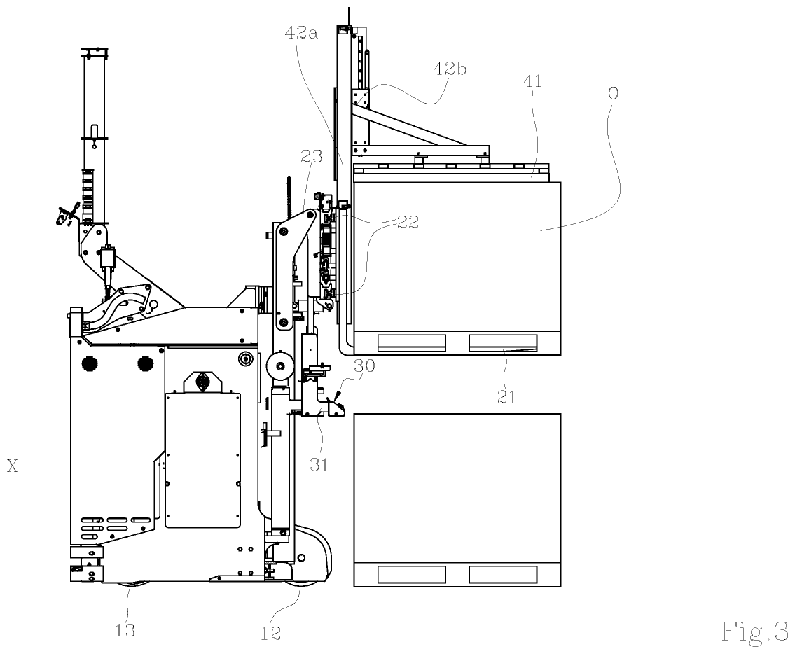

FIGS. 2 and 3 show a side view of the vehicle according to the present invention, in two different lifting positions of an object (O); some parts of the vehicle have been removed to better show others.

The operating vehicle according to the present invention comprises a self-propelled unit (10), structured to move on a movement surface along a main direction (X), following a given path.

The self-propelled unit (10) is substantially the part of the vehicle responsible for movement. The self-propelled unit (10), known in the art, essentially comprises a motor, a plurality of wheels, of which at least one connected to the motor by means of a transmission system, and a steering system, arranged to allow the self-propelled unit to follow straight trajectories and curved trajectories. The self-propelled unit (10) has an operating part (11). In the embodiment depicted, which is preferred but not exclusive, the self-propelled unit comprises two wheels (12), positioned below the operating part (11), and a steering wheel (13), positioned below the self-propelled unit (10) in an area opposite the operating part (11). The steering wheel (13) is a driving wheel and is rotatable about a vertical axis. The steering system with which the self-propelled unit (10) is provided operates by implementing the controlled rotation of the steering wheel (13) around the respective vertical axis, in a manner known in the art.

The vehicle according to the present invention further comprises a fork (20), associated with the operating part (11) of the self-propelled unit (10). The fork (20) is vertically movable between a lower position and an upper position. In the lower position, the fork (20) can be inserted below an object to be loaded on board. Typically, in the lower position the fork (20) is close to the ground. The distance from the ground is suitable to allow the insertion below the object to be loaded on board. For example, the height from the ground of the fork (20) in the lower position is suitable to allow the insertion below a standardised pallet. The upper position of the fork (20) is located at a certain height from the ground, in relation to the size and overall weight of the vehicle and the objects to be loaded, and the maximum level at which the objects are envisaged to be unloaded or picked up. The fork (20) may be arranged at any position between the lower position and the upper position.

In a possible embodiment of the vehicle, the operating part (11) is arranged in a rear area of the vehicle, i.e., an area which, during most of the movements, faces backwards with respect to the advancement direction of the vehicle. In such a case, the vehicle normally travels with the fork facing backwards, except for the steps in which the vehicle must pick up an object. In these steps, the vehicle moves in reverse, with the fork facing the object to be picked up.

In another possible embodiment of the vehicle, the operating part (11) is instead arranged in a front area of the vehicle, i.e., an area which, during most of the movements, faces forwards with respect to the advancement direction of the vehicle. In such a case, the vehicle normally travels with the fork facing forwards, including the steps in which the vehicle must pick up an object. In these steps, the vehicle moves forwards, with the fork facing the object to be picked up.

In the following description, reference will be made to a forward displacement or movement, meaning by this a displacement or movement in which the operating part (11) faces backwards, i.e., faces in the direction opposite to the advancement. The self-propelled unit (10) is however capable of moving even in reverse, i.e., in the opposite direction, turning the operating part (11) forwards with respect to the advancement direction. The loading manoeuvres of an object (O) are substantially carried out in reverse. The self-propelled unit (10) further comprises a frame, arranged to support the components mentioned above and other components of the vehicle which will not be described in detail, since these are components known in the art.

In the embodiment depicted, known in the art, the fork (20) comprises a pair of arms (21) parallel to each other and substantially horizontal, which protrude from the vehicle away from the operating part (11). Such arms (21) are intended to be inserted below the object to be loaded. The arms (21) lie on a substantially horizontal plane.

The fork (20) is associated with a movement structure, provided with guides (20a) and actuators arranged to allow vertical translation of the fork (20). Preferably, the movement structure is also arranged to allow translation of the arms (21) towards and away from each other, along a horizontal direction perpendicular to the main direction (X).

In the embodiment depicted, which is preferred but not exclusive, the fork (20) is associated with a first support (22). Such a first support (22), in turn, is connected to a second support (23), with the possibility of sliding along a horizontal direction perpendicular to the main direction (X) by means of a guide system of known type. In particular, the first support (22) allows the sliding of each arm (21) towards and away from the other arm (21). The second support (23) is connected to the operating part (11) of the self-propelled unit (10) with the possibility of sliding along a substantially vertical direction, by means of a system of guides of known type. First motor means, known in the art, are arranged to slide the first support (22) with respect to the second support (23). Second motor means, known in the art, are arranged to slide the second support (23) with respect to the self-propelled unit (10). The first and the second motor means can be activated, in a known manner, by a control module of the vehicle. Such a control module will be described in more detail in the following description.

The vehicle according to the present invention further comprises a detection sensor (30), provided with a detecting field (R) facing the fork (20), i.e., facing the space occupied by the fork (20). The space occupied by the fork (20) means the space within which the fork (20) and any object loaded on the fork (20) could hit an obstacle during a movement that has at least one direct component along the main direction (X).

In other words, the detecting field (R) is arranged so as to intercept obstacles, such as objects or people, which may be located in front of the vehicle, i.e., along the path followed by the vehicle during a movement facing the direction of the fork (20). The detection sensor (30) is arranged to emit a detecting signal if an object is inside the detecting field (R).

The detection sector (30) is a component well known in the sector, therefore it will not be described in more detail. For example, the detection sensor (30) is a PLS-type sensor.

The vehicle according to the present invention comprises a control module, connected to the self-propelled unit (10) and to the detection sensor (30). As is well known in the art, the control module mentioned in the present description and in the following claims is generically referred to as a single unit, but can in fact be provided with distinct functional modules (memory modules or operating modules), each responsible for controlling a given device or cycle of operations of the vehicle. In essence, the general control module can consist of a single electronic device, programmed to carry out the functions described, and the various functional modules can correspond to hardware components and/or software routines being part of the programmed device. Alternatively, or additionally, such functions can be performed by a plurality of electronic devices over which the aforesaid functional modules can be distributed. The units can further rely on one or more processors for the execution of the instructions contained in the memory modules.

The control module is connected at least to the following components of the vehicle, so as to control the activation and/or operation thereof: to the motor of the self-propelled unit (10), to said first and second motor means which determine the movement of the fork (20), to said steering system of the self-propelled unit (10), as well as to a possible braking system of the vehicle. The control module could also regulate the operation of other known components of the vehicle, by means of special connections.

In particular, the control module is arranged to control a safety manoeuvre of the self-propelled unit (10) in the presence of a detecting signal of the detection sensor (30). For example, in the presence of a detecting signal emitted by the detection sensor (30), the control module is arranged to stop the vehicle's motor and/or to brake the vehicle itself and/or to stop the fork (20), using control algorithms known in the art. Furthermore, the control module is arranged to guide the self-propelled unit (10), acting at least on the motor of the self-propelled unit (10) and on the steering system, along a path defined by means of one or more operating algorithms, configured in a known manner to respond to movement and/or collection needs of objects (O) within a plant or an operating area, such as a warehouse, a production plant or other.

Advantageously, in the vehicle according to the present invention the detection sensor (30) is vertically movable between a lower position and an upper position. By vertically movable is meant that the detection sensor (30) is movable by performing a movement comprising at least one vertically directed component between said lower position and upper position. The lower position is at a lower level than the level at which the upper position is located. Level means the height with respect to the rest surface of the vehicle, or with respect to the ground or surface on which the vehicle is movable.

In the lower position of the detection sensor (30), the detecting field (30) faces the fork (20), i.e. it faces the space occupied by the fork (20), when the fork (20) is in its lower position.

In the upper position of the detection sensor (30), the detecting field (30) faces the fork (20), i.e. it faces the space occupied by the fork (20), when the fork (20) is in its upper position.

In particular, the detection sensor (30) is vertically movable so that the detecting field (R) faces the fork (20), i.e. faces the space occupied by the fork (20) in any assumed position of the fork (20) between its lower and upper positions. In other words, the detection sensor (30) is movable so that the detecting field (R) is at a level useful for detecting the presence of obstacles within the space occupied by the fork (20), i.e. within the space within which the fork (20) and any object loaded on the fork (20) could hit an obstacle during a movement having at least one direct component along the main direction (X).

In essence, thanks to the possibility of the detection sensor (30) to translate vertically, the detecting field (R) can be arranged so as to intercept obstacles, such as objects or people, that should be in front of the vehicle, i.e. along the path followed by the vehicle during a movement facing the direction of the fork (20), at whatever level the fork (20) is positioned between its lower and upper positions.

The ability of the detection sensor (30) to translate vertically in the modes described above represents a significant advance over the current vehicles. In fact, the detection sensor (30) is active during the entire step of approaching the vehicle to the object to be picked up or to the position in which the unloading of an object is envisaged, at whatever level the fork (20) is positioned or during the entire step in which the fork (20) between its lower and upper positions. In the presence of an obstacle that could be hit by the fork (20) and/or by an object loaded on the fork (20), the detection sensor (30) is able to send a detecting signal to the control module, which can implement the envisaged safety manoeuvre to avoid the impact.

In a first possible preferred but not exclusive embodiment, the detection sensor (30) is vertically movable between its lower and upper positions in a manner integral with the fork (20). For example, the detection sensor (30) is associated with the fork (20) or with a structure integral with the fork (20). To this end, various solutions are within the reach of the person skilled in the sector without it being necessary to describe them in detail. This first possible embodiment allows to obtain the movement of the detection sensor (30) in a simple and economical way, since the movement system for moving the fork (20) is substantially exploited.

In a second possible embodiment, the detection sensor (30) is vertically movable between its lower and upper positions independently of the fork (20). For example, for the implementation of the vertical movement the detection sensor (30) is associated with a guide system, comprising for example a vertical guide, and with own motor means, i.e. motor means that is distinct from the motor means that implements the movements of the fork (20). In this case, the motor means of the detection sensor (30) is connected to and controlled by the control module of the vehicle. In this second possible embodiment, the positioning of the detection sensor (30) can be controlled independently of the positioning of the fork (20), and it is therefore possible to position the detection sensor (30) with greater flexibility, depending on the best position to allow the correct detection of obstacles. In the depicted, preferred but not exclusive embodiment, the detection sensor (30) is positioned in a substantially median position with respect to the arms (21) of the fork (20).

Preferably, the detection sensor (30) is connected to a support (31) which, in turn, is connected to the fork (20). For example, the first support (31) is connected to the second support (23) of the fork (20), or to another part integral with the fork (20). In the second possible embodiment synthesized above, the support (31) is instead slidable along a vertical guide, not depicted, in a manner known in the art.

The vehicle according to the present invention is further provided with a stabiliser (40), overlapping the fork (20) and spaced away from the latter by a variable amount. In particular, the stabiliser (40) is vertically movable towards and away from the fork (20). The function performed by the stabilizer (40) is to position itself above in contact with the object (O) supported by the fork (20), so as to stabilise the position thereof and prevent tipping or falling of the object (O).

The stabiliser (40) comprises a flat frame (41) defining a substantially horizontal plane. The flat frame (41) is intended to be positioned above in contact with the object (O). Motor means, known in the art, is arranged to actuate the vertical displacement of the flat frame (41). A support structure (42), provided with a vertical guide system, is connected to the flat frame (41) to support it and guide the movement thereof. In the depicted, preferred but not exclusive embodiment, the support structure (42) comprises a vertical upright (42a) along which a carriage (42b) is sliding, in turn connected to the flat frame (41).

1. An operating vehicle, comprising:
a self-propelled unit (10), structured to move on a movement surface along a given path advancing along a main direction (X);
a fork (20), associated with an operating part (11) of the self-propelled unit (10) and movable vertically between a lower position and an upper position;
a detection sensor (30), provided with a detecting field (R) and set up to emit a detecting signal if an object is inside the detecting field (R), said detecting field (R) facing the space occupied by the fork (20);
a control module, connected to the self-propelled unit (10) and to the detection sensor (30), which is set up to control a safety manoeuvre of the self-propelled unit (10) in the presence of a detecting signal of the detection sensor (30);
wherein:
the detection sensor (30) is vertically movable between a lower position and an upper position;
in said lower position of the detection sensor (30), the detecting field (30) faces the space occupied by the fork (20), when the fork (20) is in its lower position; and
in said upper position of the detection sensor (30), the detecting field (30) faces the space occupied by the fork (20), when the fork (20) is in its upper position.

2. The vehicle according to claim 1, wherein the detection sensor (30) is vertically movable between its lower and upper positions in a manner integral with the fork (20).

3. The vehicle according to claim 2, wherein the detection sensor (30) is associated with the fork (20) or with a structure integral with the fork (20).

4. The vehicle according to claim 3, wherein the detection sensor (30) is associated with a support (31) connected to the fork (20).

5. The vehicle according to claim 1, wherein the detection sensor (30) is vertically movable between its lower and upper positions independently of the fork (20).

6. The vehicle according to claim 5, wherein the detection sensor (30) is associated with a guide system and with motor means connected to said control module and controlled by said control module independently of motor means arranged for the movements of the fork (20).

7. The vehicle according to claim 1, wherein the fork (20) comprises a pair of arms (21) that are parallel to one another and substantially horizontal, which protrude from the vehicle away from the operating part (11), and wherein the detection sensor (30) is located in a substantially median position with respect to the arms (21) of the fork (20).

8. The vehicle according to claim 1, comprising a stabiliser (40), overlapping the fork (20) and spaced away from the latter by a variable amount that is movable vertically towards and away from the fork (20).
